(19) United States
(12) Patent Application Publication
(10) Pub. No.: US 2004/0068743 A1
(43) Pub. Date: Apr. 8, 2004

(54) Systems and methods for providing local broadcast of an event to event attendees

(76) Inventors: Travis J. Parry, Boise, ID (US); Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/264,607

(22) Filed: Oct. 4, 2002

(51) Int. Cl. H04N 7/18; H04N 7/20; H04N 7/16

(52) U.S. Cl. 725/62; 725/63; 725/74; 725/81

(57) ABSTRACT

Disclosed are systems and methods for providing content to an event attendee. In one embodiment, a system and a method pertain to capturing event content at an event venue, storing the captured event content, and wirelessly transmitting content to the event attendee within the event venue, the wirelessly transmitted content including at least a portion of the captured event content.

### FIELD OF THE DISCLOSURE

The present disclosure relates to broadcasting and manipulating event content. More particularly, the disclosure relates to systems and methods with which video and/or audio associated with an event may be provided to attendees of the event.

### BACKGROUND

Many enjoy attending spectator events such as baseball, basketball, football, soccer, boxing matches, and other sporting events. In addition, others enjoy non-sporting events such as plays, operas, etc.

Although it is often considered preferable to see such an event live as opposed to view it as a broadcast from one's home or other location, event attendees can miss important occurrences of the event. For example, when a professional baseball game attendee leaves his or her seat to buy some food or beverages, the attendee may miss an exciting play that occurred out on the playing field, potentially missing the most important occurrence of the event. To cite another example, persons with less expensive tickets may not be able to see what is happening on the playing field as well as someone that purchased more expensive tickets. In addition, irrespective of where one is sitting at an event, an attendee may wish to replay an important occurrence (e.g., a close play). Unless the venue at which the sporting event is being played provides such a replay on a large display, the attendee may not have the opportunity to see the replay.

Attendees of non-sporting events can also miss significant aspects of an event. For instance, where the attendee is attending an opera that is performed in a foreign language, the attendee may not understand the story line of the opera unless subtitles or supertitles are provided. Even when such subtitles or supertitles are provided, the attendee may not be able to see them clearly from his or her seat or may miss an important portion of the text.

Where an event is a television broadcast event, the attendee may be able to see more of the event than the attendee would from just watching from his or her seat if the attendee has a portable television. However, in that such broadcasts are static, the attendee may still miss event occurrences. In addition, the attendee has no control over what event content is viewed. If such control were available to the attendee, the attendee could review missed plays (even many minutes after the play occurred), replay close plays as many times as desired from different camera angles, etc. In the non-sporting event context, the attendee would be able to view event content that he or she would otherwise not be able to view in that many of these non-sporting events are not broadcast live.

As can be appreciated from the above, it would be desirable to provide event attendees with the ability to view and/or review event content, as well as control its display, while at the event.

### SUMMARY

Disclosed are systems and methods for providing content to an event attendee. In one embodiment, a system and a method pertain to capturing event content at an event venue, storing the captured event content, and wirelessly transmitting content to the event attendee within the event venue, the wirelessly transmitted content including at least a portion of the captured event content.

### BRIEF DESCRIPTION OF THE DRAWINGS

The disclosed systems and methods can be better understood with reference to the following drawings. The components in the drawings are not necessarily to scale.

FIG. 1 is a schematic view of an example system for providing and viewing event content.

FIG. 2 is a block diagram of a central computing device shown in FIG. 1.

FIG. 3 is a block diagram of a viewing device shown in FIG. 1.

FIG. 4 is a flow diagram of an example method for providing and viewing event content.

FIG. 5 is a flow diagram of an example of operation of a local broadcast control program of the central computing device shown in FIG. 2.

FIG. 6 is a flow diagram of an example of operation of a content control program of the viewing device shown in FIG. 3.

### DETAILED DESCRIPTION

As described above, event attendees can miss occurrences of the event because of their live viewing of the event. As is described herein, however, event attendees may not only attend the event, but may also view event content using a viewing device where the event content is broadcast locally at the event. In such a scenario, an attendee may bring a viewing device to the event, or rent or borrow it from an appropriate event sponsor, and view the local broadcast on the viewing device. In addition, the attendee may control the event content to view the portions he or she wishes to view whether it is live (realtime) or past (recorded). Disclosed herein are systems and methods which facilitate such viewing. Although the systems and methods are described in detail, these systems and methods are provided as examples only and are therefore not intended to limit the scope of the disclosure.

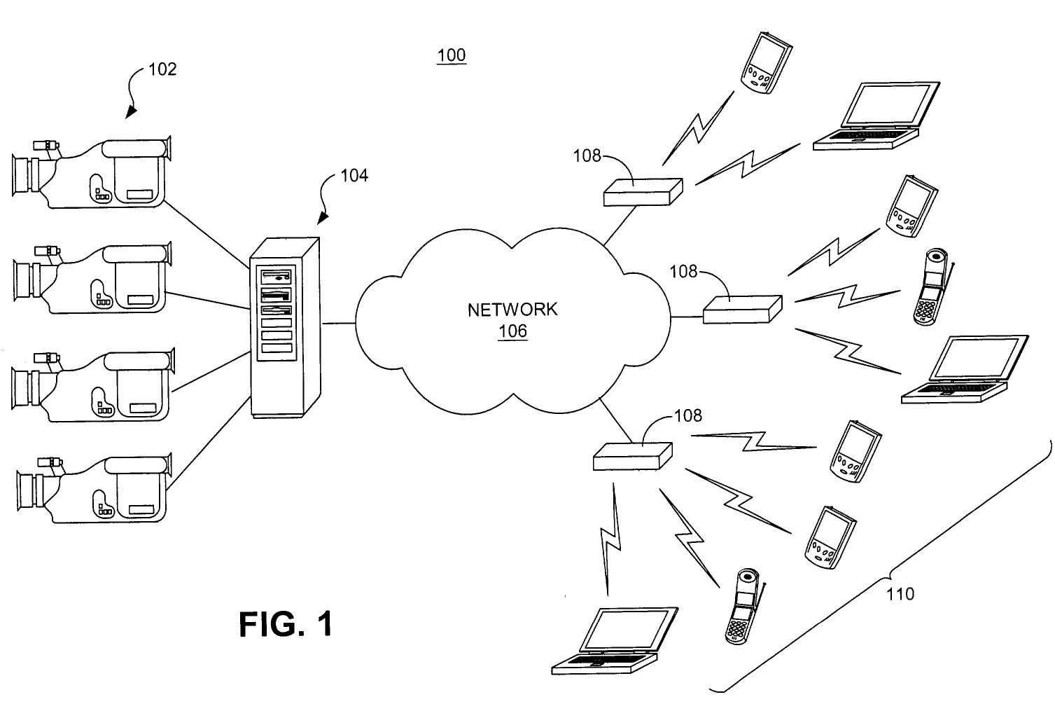

Referring now in more detail to the drawings, in which like numerals indicate corresponding parts throughout the several views, FIG. 1 illustrates an example system 100 that facilitates viewing of event content by event attendees. As indicated in FIG. 1, the system 100 comprises one or more content capture devices 102, a central computing device 104, a network 106 to which the computing device is linked, one or more transceivers 108 that are also linked to the network, and one or more viewing devices 110 that may receive transmissions from the transceivers.

The content capture devices 102 may comprise video, film, or digital cameras that are configured to capture and relay video and/or audio content to the central computing device 104. In addition, the capture devices 102 may be configured to capture and relay other content such as radar readings, temperature readings, humidity readings, etc. By way of example, the content capture devices 102 may be provided at various different locations at an event so that video and/or audio content (i.e., event content) may be captured from several different perspectives (e.g., camera angles, microphone locations, etc.).

The central computing device 104 comprises a computer or computer system that is configured to receive, store, and relay the event content captured by the content capture devices 102. Although the central computing device 104 is described generically herein as a single “device,” the device 104 may represent two or more such devices (e.g., server computers) that provide the stated functionality. As is discussed in greater detail below, the central computing device 104 acts as a hub for all event content captured during the event and therefore facilitates viewing of the content by event attendees. By way of example, the central computing device 104 is located at the event venue, however, the device may be located elsewhere, particularly where the device is linked to the video capture devices 102 via a network (not shown). Moreover, although a central computing device 104 is identified, the functionality of this identified device could, alternatively, be provided by another system component such as a content capture device 102 or transceiver 108. Therefore, one or more of the system components may be combined, if desired.

The network 106 comprises a single network or two or more sub-networks that are communicatively coupled to each other. In some embodiments, the network 106 may comprise one or more networks that form part of the Internet. This network 106 is used to relay the event content (video and/or audio) from the central computing device 104 to the one or more transceivers 108, which may be strategically positioned at various different locations of the event venue. In addition, the transceivers 108 may be used to transmit certain supplemental content. As depicted in FIG. 1, the transceivers 108 are configured to wirelessly transmit the content delivered by the network 106 to the one or more viewing devices 110. The transmission can be facilitated with substantially any appropriate wireless local transmission protocol. For example, the content can be transmitted using a local radio frequency (RF) protocol such as wireless application protocol (WAP), ultrawideband (UWB) protocol, 802.11b protocol from the Institute of Electrical and Electronics Engineers (IEEE), or Bluetooth™ protocol from Bluetooth SIG™.

The viewing devices 110 are configured to receive the content transmitted by the transceivers 108 and present it to the attendee for viewing and/or hearing. In addition, as is described in greater detail below, the viewing devices 110 may be used to control what content is viewed as well as the format of the viewed content to suit the attendee's preferences. In some embodiments, the viewing devices 110 comprise portable viewing devices such as personal digital assistants (PDAs), mobile telephones, and notebook or tablet computers. In other embodiments, the viewing devices 110 may be fixed devices, for instance mounted to the back rests of seats of the event venue. Although particular viewing devices are shown in FIG. 1 and have been described herein, substantially any device that can present and control locally broadcast content can be used.

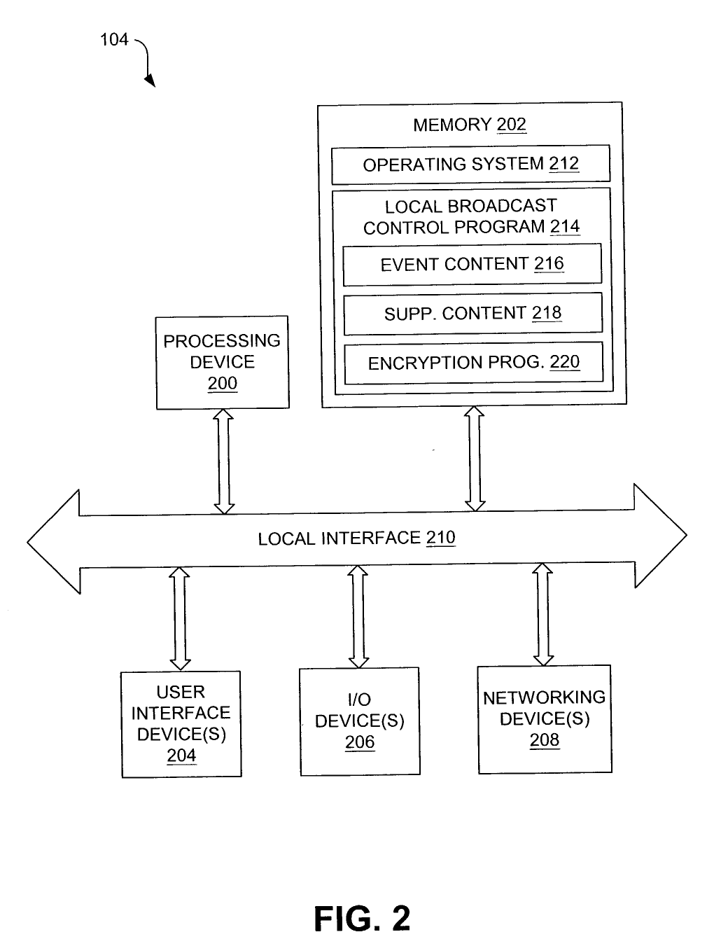

FIG. 2 is a block diagram of an example architecture for the central computing device 104 shown in FIG. 1. As indicated in FIG. 2, the computing device 104 (or each where more than one is used) can, for instance, comprise a processing device 200, memory 202, one or more user interface devices 204, one or more input/output (I/O) devices 206, and one or more networking devices 208, each of which is connected to a local interface 210 that can comprise one or more internal and/or external buses.

The processing device 200 can include any custom made or commercially available processor, a central processing unit (CPU) or an auxiliary processor among several processors associated with the computing device, a semiconductor based microprocessor (in the form of a microchip), or a macroprocessor. The memory 202 can include any one of a combination of volatile memory elements (e.g., RAM, such as DRAM, SRAM, etc.) and nonvolatile memory elements (e.g., ROM, hard disk, tape, CDROM, etc.).

The one or more user interface devices 204 comprise those components with which a system administrator can interact with the central computing device 104. By way of example, these components comprise a keyboard and mouse, as well as a display such as a computer monitor.

The one or more I/O devices 206 comprise components used to facilitate connection of the computing device 104 to other systems or devices. These I/O devices 206 can, for instance, comprise one or more serial, parallel, small system interface (SCSI), universal serial bus (USB), IEEE 1294 (e.g., Firewire™), connection devices. The networking devices 208 comprise the various components used to transmit and/or receive data over the network 106. By way of example, the networking devices 208 include a device that communicates both inputs and outputs, for instance, a network card, modulator/demodulator (e.g., modem), wireless (e.g., radio frequency (RF)) transceiver, a telephonic interface, a bridge, a router, etc.

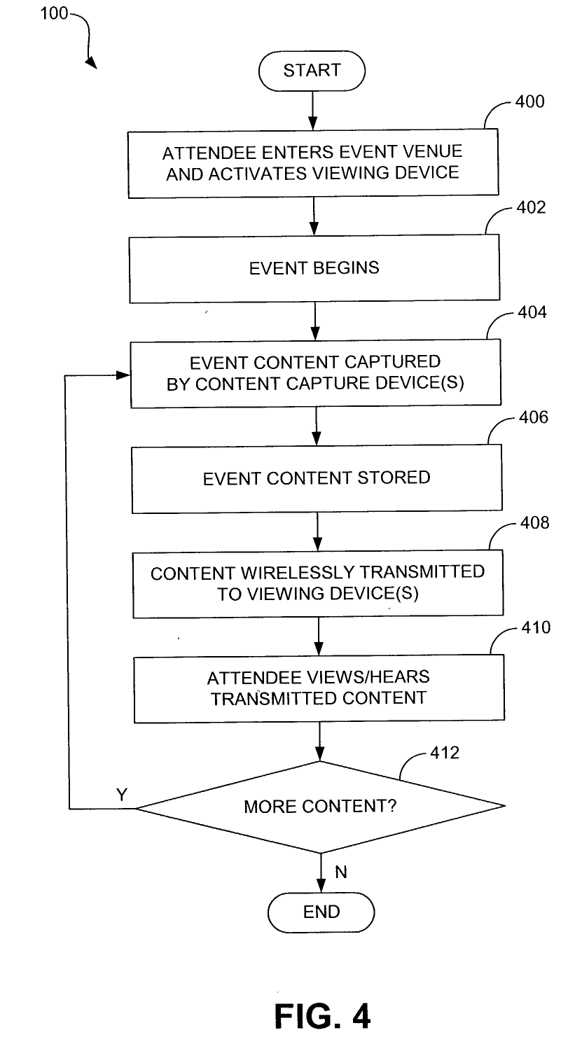

With further reference to FIG. 2, the memory 202 comprises various programs (software and/or firmware including) an operating system 212 and a local broadcast control program 214 that is used to collect the event content captured by the capture devices 102 and transmit the content, via the network 106 and the transceivers 108, to the viewing devices 110. As indicated in FIG. 2, the control program 214 may included stored (e.g., buffered) event content 216 including video and/or audio captured from the event itself, and supplemental content 218 that may be additionally provided to the attendee for viewing and/or hearing. In addition to those elements, the control program 214 may include an encryption program 220 that is used to ensure that only eligible attendees may view the locally broadcast content. Operation of the local broadcast control program 214 is described with relation to FIGS. 4-6 below.

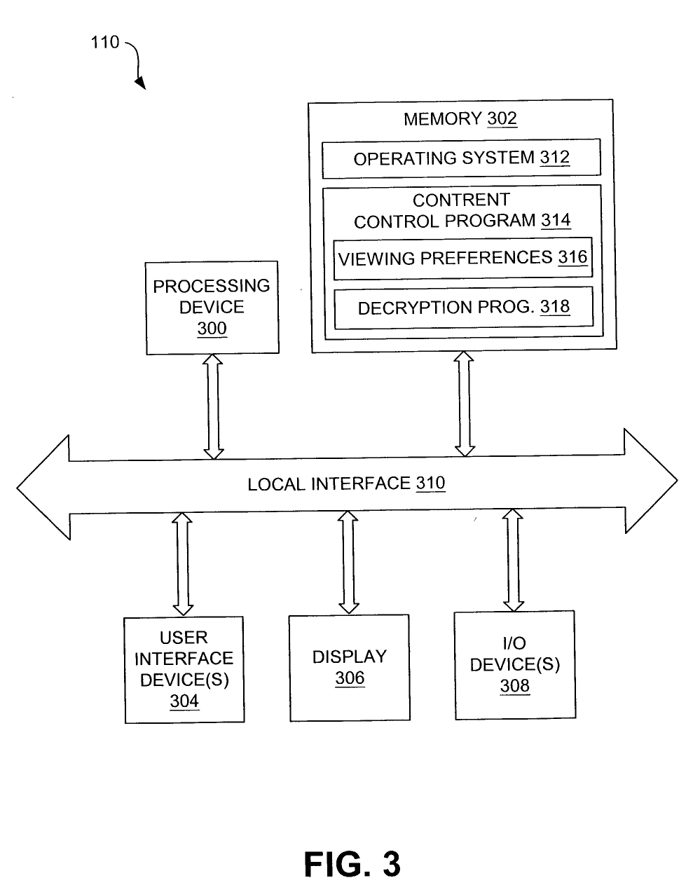

FIG. 3 is a block diagram of an example configuration for the viewing devices 110 shown in FIG. 1. As indicated in FIG. 3, each viewing device 110 comprises a processing device 300, memory 302, user interface devices 304, a display 306, and one or more I/O devices 308. Each of these components is connected to a local interface 310 that, by way of example, comprises one or more internal buses.

The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the viewing device 110. The memory 302 can include any one of a combination of volatile memory elements (e.g., random access memory (RAM)) and nonvolatile memory elements (e.g., Flash memory, magnetic random access memory (MRAM), atomic resolution storage (ARS), etc.).

The user interface devices 304 comprise the interface tools with which the device settings can be changed and through which the user can communicate commands to the device 110. These interface devices 304 typically one or more buttons or keys. In addition, the interface devices 304 may comprise a touch-sensitive screen. The display 306 is adapted to present video content to the attendee. In some embodiments, this display 306 may serve the dual purpose of displaying video content as well as serving as a user interface device 304 where the display is touch sensitive (e.g., touch sensitive liquid crystal display).

The one or more I/O devices 308 comprise components used to facilitate communications with other devices. These I/O devices 308 can, for instance, comprise one or more serial, parallel, small system interface (SCSI), universal serial bus (USB), or IEEE 1394 (e.g., Firewire™) connection devices. In addition, these I/O devices 308 comprise one or more wireless communication devices that are capable of receiving content transmitted by the transceivers 108 and, optionally, transmitting information to the transceivers. These communication devices are configured to use the protocol used by the transceivers 108 and therefore may be, for example, configured for local WAP, UWB protocol, 802.11b protocol, or Bluetooth™ protocol communications.

The memory 302 includes various programs (software and/or firmware) including an operating system 312 and content control program 314. The operating system 312 contains the various commands used to control the general operation of the viewing device 110. The content control program 314 is configured to receive the content transmitted by the transceivers 108 and format it, in view of the selections made by the attendee, for presentation to the attendee. As indicated in FIG. 3, the content control program 314 may comprise stored viewing preferences 316 as well as a decryption program 318 that is used to decrypt encrypted content in transmission schemes in which only select attendees may view certain content. Operation of the content control program 314 is described below with regard to FIGS. 4-6.

Various programs have been described herein. It is to be understood that these programs can be stored on any computer-readable medium for use by or in connection with a computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. A “computer-readable medium” can be any means that can store, communicate, propagate, or transport a program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, RAM, ROM, an erasable programmable read-only memory (EPROM, EEPROM, or flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

As described above, the disclosed systems enable event attendees to view event content that is broadcast locally at the event. FIGS. 4-6 provide flow diagrams that present example methods with which such content, as well as other content, may be provided to and viewed by such an attendee. Any process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

FIG. 4 provides an overview of operation of the system 100. Beginning with block 400 of FIG. 4, the attendee enters the event venue and activates the viewing device. The viewing device may be the attendee's own personal viewing device (e.g., PDA), or may comprise a viewing device that the attendee rented at the venue or is permitted to use as a consequence of having purchased a ticket. In any case, once the event begins, as indicated in block 402, event content is captured by the content capture devices, as indicated in block 404. As identified above, this content may comprise video and/or audio of the event, as well as any supplemental content. Therefore, this content may pertain to action on a playing field of a sporting event, performance of an actor in a play or opera, etc.

The event content that is received from the content capture devices is stored, as indicated in block 406, so that the content will be available for later viewing. By way of example, this content is stored in the central computing device. In addition, typically simultaneously, all content to be provided to the attendees is transmitted wirelessly to the viewing devices, as indicated in block 408, via the transceivers provided at the event venue. This content includes all event content that has been received from the capture devices, as well as any supplemental content that is to be provided. By way of example, this supplemental content may comprise content pertinent to the event or its participants such as, for example, player statistics, performer biographical information, radar readings, scoreboards, time clocks, subtitles, and any other information that the attendee may be interested in receiving. In addition, the supplemental content can comprise instructions as to how the event and/or other supplemental content is to be presented to the user. For instance, these instructions may include default onscreen locations for various event and/or supplemental content. Notably, although all of this content is transmitted, certain attendees may only be able to view/hear certain portions of the content. For instance, a baseline content transmission may be made available to all attendees free of charge (e.g., static broadcast with no supplemental content) while more detailed content (multiple camera angles, statistics, etc.) may be provided as a package viewable/hearable only in exchange for a fee. As is discussed below, control over this additional content may be provided via an appropriate security scheme such as an encryption scheme.

Once the content is transmitted, the attendee may then view and/or hear the content, as indicated in block 410. With reference then to decision block 412, it is determined whether there is more content available. If not, flow is terminated. If, on the other hand, there is more content to, for example, view and/or hear, flow returns to block 404 and continues in the manner described above.

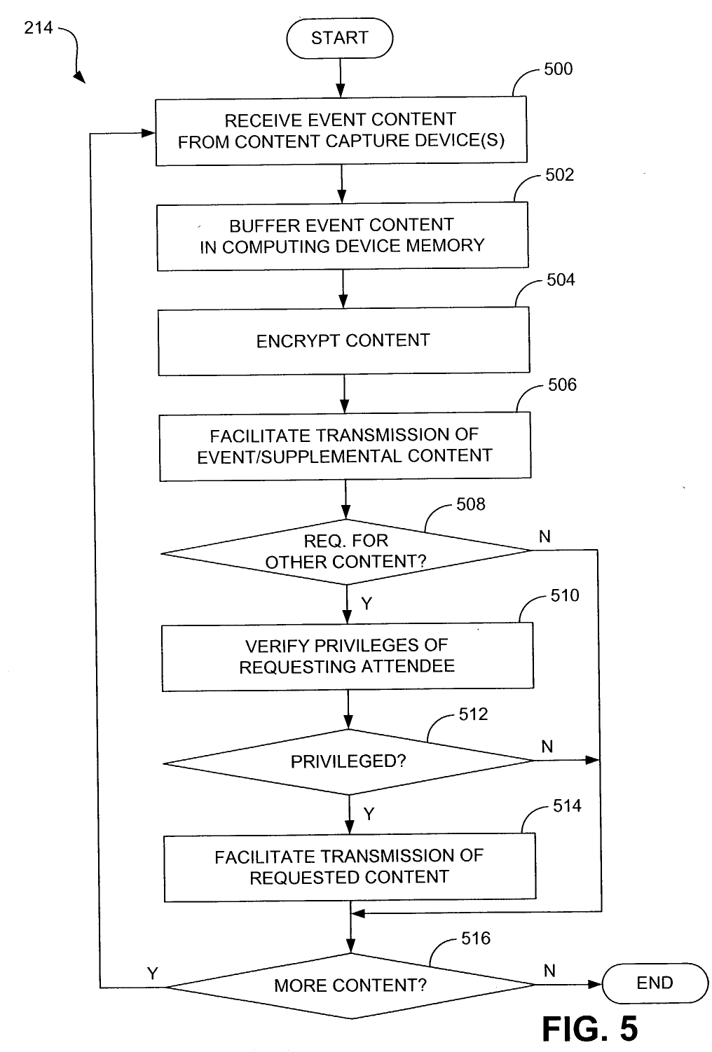

FIG. 5 provides an example of operation of the local broadcast control program 214 of the central computing device 104 in facilitating the broadcast of content to event attendees. Beginning with block 500 of this figure, the control program 214 receives event content (video and/or audio) from the content capture devices and, as indicated in block 502, this content is buffered within device memory. At this point, all or portion of the content can be encrypted, as indicated in block 504, to restrict access to content after it is transmitted. By way of example, the content can be encrypted in a manner in which decryption can only be achieved through the provision of an appropriate code (i.e., key) that the attendee must provide. In such a case, the attendee may enter a code provided on his or her ticket or otherwise provided to the attendee prior to commencement of the event. This code may be provided to the attendee in exchange for a fee included in or separate from the amount paid for the event ticket. Where content is provided as included with the ticket price, the amount and/or nature of the content may be varied depending upon how much has been paid. In scenarios in which such restriction of access is not necessary or desired, the encryption step (504) may be skipped.

Next, with reference to block 506, the local broadcast control program 214 facilitates transmission of the event content, and any supplemental content, to the viewing devices. This facilitation comprises packaging the various content into data packets that are sent to the transceivers for wireless transmission. Typically all realtime event content (e.g., all camera views) and any pertinent supplemental content is transmitted at the same time in the broadcast even though certain portions may only be available to certain attendees (e.g., those who paid a fee).

Referring to decision block 508, it can be determined whether there are any requests for past event content or other content not currently being broadcast. For instance, if a particular attendee wishes to review a close call that occurred in a previous inning of a baseball game, the attendee may submit a request to view that play. In such a case, the request may take the form of a request to view event content that occurred during a specific time period (absolute time), time in the event (e.g., of a game clock), or where certain occurrences have been designated particular identifiers (e.g., numbered occurrences available for replay), the particular identifier. In any case, the local broadcast control program 214 can verify the privileges of the requesting attendee, as indicated in block 510. Where no privileges are required (e.g., where this feature is free), privilege is presumed in block decision 512 and, as indicated in block 514, the control program facilitates transmission of the requested content to the attendee. By way of example, this transmission can be restricted to the particular requesting attendee through use of a recipient identification particular to that attendee. Alternatively or in addition, the transmission can be transmitted across several different frequencies in sequence using a frequency-hopping scheme where the viewing device is configured to likewise change frequencies to receive the transmission.

Where authority is needed for the requested content, privilege can be determined in a variety of different ways. In one scenario, a public key encryption scheme can be used in which, along with the request, the attendee transmits the attendee's public key to the local broadcast control program 214 via the transceivers. The attendee's public key is then used to encrypt the content (data packets) such that only that attendee, using the attendee's private key, can decrypt, and therefore view, the transmitted content.

If the attendee is not privileged (512) or has been provided the requested content (514), flow continues to decision block 516 at which it is determined whether there is more content available. If not, flow is terminated for the session. If there is more content available, however, flow continues back to block 500 and new event content is continued to be received.

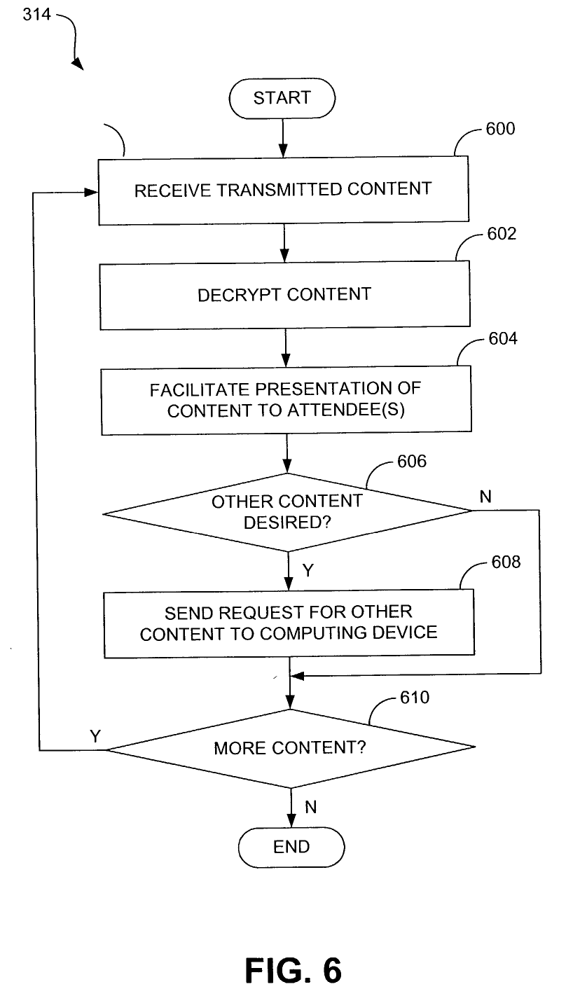

FIG. 6 illustrates an example of operation of the content control program 314 of the viewing device 110. As indicated in block 600, the program 314 receives content transmitted from the transceivers. Assuming that all or a portion of the content is encrypted so as to restrict viewing of the content to select (e.g., paying) attendees, the program 314 decrypts the content, as indicated in block 602, using the decryption program 318. As described above with reference to FIG. 5, this decryption can entail decrypting the content using a code (i.e., key) provided to the attendee on the attendee's ticket or otherwise. Once the content is decrypted, the content control program 314 facilitates presentation of the transmitted content to the attendee, as indicated in block 604. This presentation of content may be controlled with reference to the viewing preferences 316 that have been stored by the attendee, either on the viewing device or within the central computing device memory. The attendee can view realtime footage of the event or other event content that is being broadcast, as well as any supplemental content that is broadcast. Accordingly, the attendee can view and/or hear content that he or she may not otherwise be able to obtain.

During the viewing/hearing, the attendee may control the format of the content and, where different types of content are available to the attendee, which content is viewed. For example, where multiple camera angles are available, the attendee can select (using the user interface devices) which angle or angles is/are viewed, what supplemental content (e.g., scoreboard, statistics, subtitles) is viewed, etc. This flexibility enhances the attendees experience and permits the attendee to obtain the information in which he or she is most interested.

Next, with reference to decision block 606, it is determined whether other content, such as past event content or supplemental content not currently being broadcast, is desired. If so, a content request can be transmitted to the central computing device, as indicated in block 608, via the transceivers. As mentioned above in reference to FIG. 5, this transmission can, optionally, include the attendee's public key for purposes of encrypting the content that will be sent back to the attendee.

If no such other content is desired (606) or the request has been sent (608), flow continues to decision block 610 at which it is determined whether more content is available. If not, flow is terminated. If so, however, flow continues back to block 600 and new content continues to be received.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for providing content to an event attendee, comprising:
capturing event content at an event venue;
storing the captured event content; and
wirelessly transmitting content to the event attendee within the event venue, the wirelessly transmitted content including at least a portion of the captured event content.

2. The method of claim 1, wherein the step of capturing event content comprises capturing video content.

3. The method of claim 1, wherein the step of storing the captured event content comprises buffering the captured event content in memory of a central computing device.

4. The method of claim 1, wherein the step of wirelessly transmitting content to the event attendee comprises wirelessly transmitting content to a portable viewing device of the attendee.

5. The method of claim 1, wherein the step of wireless transmitting content to the event attendee comprises wirelessly transmitting event content and supplemental content relevant to the event content.

6. The method of claim 1, further comprising the step of encrypting at least a portion of the transmitted content.

7. The method of claim 1, further comprising verifying an attendee's privilege for certain content prior to transmitting that content to the attendee.

8. A method for providing event content to event attendees at an event venue, comprising:
receiving event content captured by multiple content capture devices positioned at different locations within the event venue;
buffering the event content within memory of a central computing device so that the event content will be available for later viewing; and
broadcasting event content and supplemental content within the event venue to viewing devices of event attendees so that the attendees may view the captured event content and the supplemental content.

9. The method of claim 8, wherein the step of broadcasting comprises wirelessly broadcasting event content and supplemental content with multiple transceivers positioned at different locations within the event venue.

10. The method of claim 8, further comprising the step of encrypting at least a portion of the transmitted content.

11. The method of claim 8, further comprising verifying an attendee's privilege for certain content prior to transmitting that content to the attendee.

12. The method of claim 8, further comprising receiving requests from attendees for content that is not currently being broadcast.

13. The method of claim 12, further comprising determining whether the requesting attendees are privileged to receive the requested content and, if so, transmitting the requested content to the requesting attendees.

14. A system for providing content to an event attendee, comprising:
a content capture device that is configured to capture event content that occurs at an event;
a central computing device that receives the captured event content from the content capture device;
a transmission device that, under the control of the central computing device, wirelessly transmits content within the event venue; and
viewing devices that receive the transmitted content at the event venue.

15. The system of claim 14, wherein the content capture device comprises a camera.

16. The system of claim 14, wherein the transmission device comprises a wireless transceiver.

17. The system of claim 14, wherein the viewing devices comprise at least one of a personal digital assistant (PDA), mobile telephone, a notebook computer, and a tablet computer.

18. A local broadcast control program stored on a computer-readable medium, comprising:
logic configured to receive captured event content;
logic configured to store the captured event content; and
logic configured to facilitate transmission of content including at least a portion of the captured content within an event venue to event attendees.

19. The program of claim 18, further comprising logic configured to encrypt content prior to its transmission.

20. The program of claim 18, further comprising logic configured to verify the privilege of an attendee to receive certain content.

21. A content control program stored on a computer-readable medium, comprising:
logic configured to receive content transmitted at an event venue;
logic configured to decrypt encrypted portions of the transmitted content;
logic configured to facilitate presentation of the transmitted content to an event attendee; and
logic configured to send a request for additional content to a central computing device that initiated the transmission of content to the content control program.

22. A computing device, comprising:
a processing device; and
memory including a local broadcast control program having logic configured to receive captured event content, logic configured to store the captured event content, and logic configured to facilitate transmission of content including at least a portion of the captured content within an even venue to event attendees.

23. The device of claim 22, wherein the local broadcast control program further comprises logic configured to encrypt content.

24. The device of claim 22, wherein the local broadcast control program further comprises logic configured to verify the privilege of an attendee to receive certain content.

25. A portable viewing device, comprising:
a processing device;
memory including a content control program having logic configured to receive content transmitted at an event venue, logic configured to decrypt encrypted portions of the transmitted content, logic configured to facilitate presentation of the transmitted content to an event attendee, and logic configured to send a request for additional content to a central computing device that initiated the transmission of content to the content control program; and
a display configured to present the transmitted content to the attendee for viewing.
